(19) United States
(12) Patent Application Publication
(10) Pub. No.: US 2023/0217481 A1
(43) Pub. Date: Jul. 6, 2023

(54) COMMUNICATION SYSTEM WITH CELLULAR AND WIRELESS LOCAL AREA NETWORK INTEGRATION

(71) Applicant: CommScope Technologies LLC, Hickory, NC (US)

(72) Inventor: Rajesh Kaliaperumal, San Jose, CA (US)

(73) Assignee: CommScope Technologies LLC, Hickory, NC (US)

(21) Appl. No.: 18/148,755

(22) Filed: Dec. 30, 2022

Related U.S. Application Data
(60) Provisional application No. 63/296,985, filed on Jan. 6, 2022.

(51) Int. Cl. H04W 72/543; H04W 72/12; H04W 72/566

(52) U.S. Cl. CPC H04W 72/543; H04W 72/12; H04W 72/569; H04W 84/12

(57) ABSTRACT

A method of operating a communication system with cellular and wireless local-area network (WLAN) integration is provided. The method comprising in a downlink direction, selecting user information to be communicated to user equipment (UE) using a WLAN service; communicating quality of service (QoS) information associated with the user information generated by a cellular network to a WLAN access point; using a scheduler of the of WLAN access point to schedule downlink resources based on the QoS information; and wirelessly communicating the user information associated with the QoS information through the WLAN access point to at least one user equipment (UE) based on the scheduling of downlink resources by the scheduler.

### CROSS-REFERENCE TO RELATED APPLICATIONS

This application claims priority to U.S. Provisional Application Ser. No. 63,296,985, same title herewith, filed on Jan. 6, 2022, which is incorporated in its entirety herein by reference.

### BACKGROUND

As consumer demands for more and more information be available through user equipment (UE) grows, solutions to increase throughput of information is sought. One solution is by integrating available wireless local-area network (WLAN) resources with cellular systems. As used here, “cellular” systems or devices refer to systems or devices that use licensed radio frequency (RF) spectrum, whereas “WLAN” systems or devices refer to systems or devices that use unlicensed radio frequency (RF) spectrum. One example of WLAN technology is the WLAN technology that supports one or more of the Institute of Electrical and Electronics Engineers (IEEE) 802.11 family of wireless standards and/or the certifications provided the WiFi Alliance in connection with the name “WiFi.”

Standards provided by the third-generation project (3GPP) are currently used in cellular communication systems. 3GPP fourth generation (4G) uses an internet packet (IP)-based packet-focused evolved packet core (EPC) with orthogonal frequency division multiple access (OFDMA). In 3GPP fifth generation (5G) this is called Next Generation Core (NGC). OFDMA allows multiple users with varying bandwidth needs to be served simultaneously by dividing up the spectrum and allocating channels within the spectrum to multiple different users when necessary. 3GPP uses a quality of service (QoS) that relates to traffic prioritization and resource reservation control. With 3GPP 5G, a protocol data unit (PDU) session provides end-to-end plane connectivity between a UE and a specific data network through a user plane function (UPF). A PDU session supports one or more QoS flows. Further, a QoS flow identifier (QFI) is used for each flow.

With the integration of cellular and WLAN, 3GPP 5G supports WLAN access integration at a core network level through a non-3GPP interworking function (N3IWF) and a trusted non-3GPP gateway function (TNGF). These gateway functions are for untrusted and trusted WLANs. A trusted WLAN is a type of non 3GPP access network which has a trust relationship with the 3GPP core network. An untrusted WLAN includes any type of WLAN access that the operator has no control over, such as public hotspots. It also includes WLAN access that does not provide sufficient security mechanisms such as authentication and radio link encryption. The 5G core network is designed to be access neutral so that the same N2/N3 interfaces used by the 3GPP cellular access may be used for WLAN access.

Since WLAN was originally conceived as a simple extension of a wired Ethernet networking to provide short-range wireless local area coverage between devices, general network considerations such as radio measurements and statistics, device management and QoS were not originally addressed. Radio resources need to be allocated to accomplish a desired bitrate per the QFI at a WLAN access point. However, the allocation of such radio resources is not defined in the 3GPP specification.

For the reasons stated above and for other reasons stated below which will become apparent to those skilled in the art upon reading and understanding the present specification, there is a need in the art for an effective and efficient system to allocate radio resources at the WLAN access point in a communication system with cellular and WLAN integration.

### SUMMARY OF INVENTION

The following summary is made by way of example and not by way of limitation. It is merely provided to aid the reader in understanding some of the aspects of the subject matter described. Embodiments provide a system to allocate radio resources at the WLAN access point with a WLAN scheduler to achieve desired bitrates per each QFI based on a QoS value.

In one embodiment, a method of operating a communication system with cellular and wireless local-area network (WLAN) integration is provided. The method comprising in a downlink direction, selecting user information to be communicated to user equipment (UE) using a WLAN service; communicating quality of service (QoS) information associated with the user information generated by a cellular network to a WLAN access point; using a scheduler of the WLAN access point to schedule downlink resources based on the QoS information; and wirelessly communicating the user information associated with the QoS information through the WLAN access point to at least one user equipment (UE) based on the scheduling of downlink resources by the scheduler.

In another embodiment, a communication system with cellular and wireless local-area network (WLAN) integration is provided. The communication system includes a cellular base station, a WLAN access point, and gateway functions for non-3GPP access. The cellular base station provides a cellular wireless service to user equipment (UE). The cellular base station includes cellular functions defined by third-generation project (3GPP). The WLAN access point provides a WLAN wireless service to the UE. The WLAN access point includes a schedular. The cellular base station is configured to receive, using the gateway functions, quality of service (QoS) information associated with user information generated by a cellular packet core. The gateway functions are configured to map the QoS information and communicate the mapped QoS information to the WLAN access point. The scheduler of the WLAN access point configured to schedule resources for the WLAN wireless service based on the QoS information mapped by the gateway function.

In still another embodiment, a communication system with cellular and wireless local-area network (WLAN) integration is provided. The communication system includes a cellular base station in communication with a cellular packet core with gateway functions for non-3GPP access. The cellular base station includes cellular functions defined by third-generation project (3GPP) and gateway functions for non-3GPP access. The communication system further includes a radio unit to provide the cellular wireless service. The radio unit comprising a WLAN access point configured to provide WLAN wireless service.

### BRIEF DESCRIPTION OF THE DRAWINGS

The present invention can be more easily understood and further advantages and uses thereof will be more readily apparent, when considered in view of the detailed description and the following figures in which:

FIG. 1 is a simplified block diagram of a communication system with cellular and WLAN integration according to one exemplary embodiment.

FIG. 2A is a downlink link flow diagram according to one exemplary embodiment.

FIG. 2B is a downlink link flow diagram according to one exemplary embodiment.

FIG. 3 is a block diagram of a communication system with cellular and WLAN integration according to one exemplary embodiment.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

Embodiments use 5G UE communication credentials to also access WLAN. In one example, a scheduler of a WLAN access point is configured to allocate radio resources in the WLAN to achieve a desired bitrate based on a received QFI. This provides a communication system that can hand off 5G communications (or at least certain traffic within the 5G communications) to the WLAN.

Unless explicitly stated to the contrary, references to Layer 1, Layer 2, Layer 3, and other or equivalent layers (such as the Physical Layer or the Media Access Control (MAC) Layer) refer to layers of the particular wireless interface (for example, 4G LTE or 5G NR) used for wirelessly communicating with user equipment (UE). Furthermore, it is also to be understood that 5G NR embodiments can be used in both standalone and non-standalone modes (or other modes developed in the future) and the following description is not intended to be limited to any particular mode. Moreover, the software and hardware used to implement a radio access network may also generally be referred to here as “entities” or “radio access network entities.”

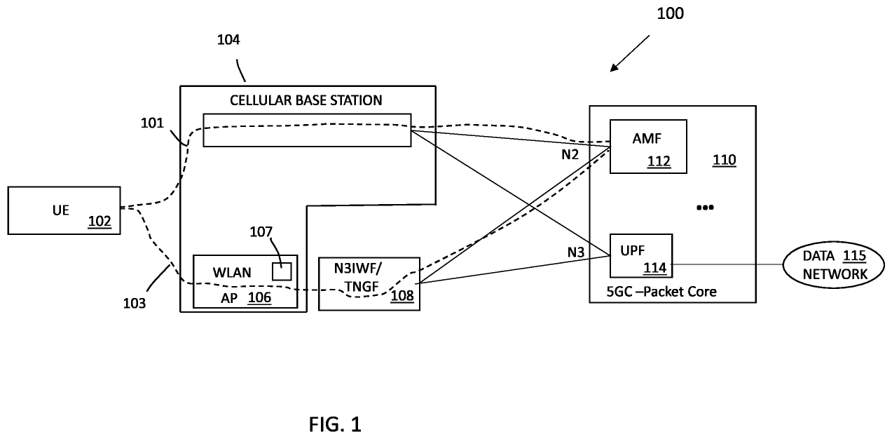

FIG. 1 illustrates a simplified block view of a communication system 100 with cellular and WLAN integration. FIG. 1 illustrates at least one UE 102 that is in communication with a 5G packet core 110 via cellular communication path 101 or a WLAN communication path 103. In this example, a 5G new radio (NR) base station 104 (which may also be referred to a “cellular base station,” a “gNodeB” or a “gNB”) includes a WLAN access point 106. The cellular base station 104 provides a cellular air interface for 5G networks as well as a WLAN access point 106 (access point) within the WLAN communication path 103. The WLAN access point may include a WLAN controller. Gateway functions of the N3IWF/TNGF 108 are used in the WLAN path 103 as discussed in detail below.

In one example, the N3IWF/TNGF 108 may be co-located or implemented in the WLAN controller. In another example, the N3IWF/TNGF 108 are part of the packet core 110. The gateway functions provide the QoS to the WLAN access point 106.

A WLAN access point 106 (which may be referred to as a “WLAN base station”), provides WLAN wireless service to the UE 102 by which the UE 102 can access the WLAN communication path 103. The WLAN access point includes a scheduler 107 to schedule downlink and uplink resources for the WLAN wireless service. In a WLAN 6/6E example, OFDMA is used for scheduling uplink and downlink resources. Since WLAN service works on a listen before transmit technology, the scheduler 107 needs to wait for a channel to become available before a transmission can occur.

The packet core 110 includes an access and mobility management function (AMF) 112 and a user plane function (UPF) 114. The tasks of the AMF 112 include registration management, connection management, reachability management, mobility management and various functions relating to security, access management and authorization. The UPF 114 provides packet processing including packet routing and forwarding, interconnection to data networks (such as data network 115), policy enforcement and data buffering.

In 5G, the convergence of 3GPP access and non-3GPP access includes changes over previous generations. For example, the convergence function is a peer entity to the logical 5G radio node (gNB). It is neither a radio access network (RAN) centric solution nor a core-centric solution. Also, trusted and untrusted methods of access are identical. In trusted access, a secure tunnel is optional. In addition, access, traffic, steering, switching and splitting (ATSSS) is used to define how a policy is provisioned in the UE 102.

Although 3GPP has defined the architecture to enable non-3GPP access, there are still some challenges to implementation. The challenges include the UE 102 implementation of ATSSS and QoS handling on the WLAN access point 106. ATSSS has a feature where traffic flowing within a PDU can be split across different access technologies. ATSSS rules are installed onto each UE 102 by a policy control function (PCF) via the AMF 112 as part of a PDU establishment procedure.

There are several protocols currently commercially available for a UE 102. For example, an iPhone® uses multipath TCP (MPTCP) for Siri®. MPTCP is now part of an application development kit used by application developers. Further MP-QUIC is implemented in Android™ devices (largely used by Google services). Functionally, ATSSS is like the MPTCP or other multipath protocols. 3GPP has defined ATSSS to coexist with/among other multipath protocols.

When the UE 102 registers with N3IWF/TNGF, the UE 102 is authenticated by the AMF 112 using authentication server function (AUSF). At the end of the registration process, a security association (SA) (such as an internet protocol secure (IPSec) association) is established. Subsequently, a Child_SA is established for the PDU session. A Child_SA manages and contains a state of an IPsec security association. Defining one Child_SA per QoS flow identifier (QFI) (AMF 112 sends the QFI to the N3IWF/TNGF 108 as part of PDU establishment) or one Child_SA for all QFIs/PDUs is implementation specific. A trusted non-3GPD gateway (TNGF) sets up IPSec SA with “Null” encryption.

The QFI for PDU session(s) is known to N3IWF/TNGF 108 and the N3IWF/TNGF 108 enforces the QFI in the N3 interface to the UPF 114. As part of the PDU establishment, the UE 102 receives a differential service code point (DSCP) value that is used on an IP header of all packets sent to the network (encrypted or not encrypted) to help QoS enforcement between access point (AP) and N3IWF/TNGF 108.

It is also important that the WLAN access point 106 allocate radio resources to accomplish the bitrates per the QFI. However, this is not defined in the 3GPP specification. As discusses above, embodiments provide a system to allocate radio resources to accomplish the bitrates per the QFI.

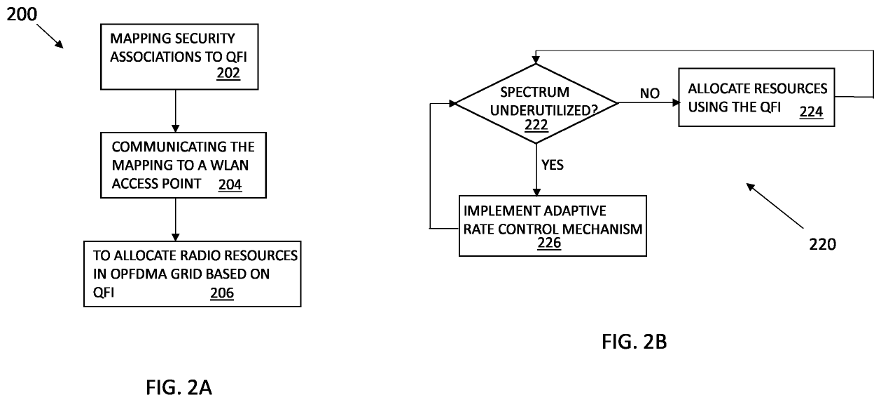

An example of an allocation radio resources in the downlink direction (communications from the core 110 to a UE 102) is provided in the downlink link flow diagram 200 of FIG. 2A. The downlink flow diagram 200 is provided as a sequence of blocks. The sequence of the blocks may be in a different order or in parallel in other embodiments. Hence, embodiments are not limited to the sequential sequence of blocks set out in FIG. 2A.

In a downlink (DL) direction, security associations (Child_SAs) are mapped to the QFI as set out in block (202). The gateway functions (N3IWF/TNGF 108) communicate the mapping to the WLAN access point 106 at block (204). The scheduler 107 in the WLAN access point 106 uses this QFI information to allocate the radio resources in an OFDMA grid at block (206). The QFI information at the WLAN access point 106 helps the scheduler 107 to ensure prioritization of traffic during the transmit opportunity. This helps maintain service level agreements (SLAs) even in a congested environment where radio resources are limited, and the number of UEs are high. An example of one such environment is a public venue such as a shopping mall.

The QFI may not only define the bitrates (Guaranteed, minimum and maximum) for each downlink flow, the QFI may also define the bitrates for each uplink flow. An example of an allocation radio resources in the uplink direction (communications from the UE 102 to the core 110) is provided in the uplink link flow diagram 220 of FIG. 2B. The uplink flow diagram 220 is also provided in a sequence of block. The sequence of the blocks may be in a different order or in parallel in other embodiments. Hence, embodiments are not limited to the sequential sequence set out in FIG. 2B.

The scheduler 107 allocates radio resources using the QFI in the uplink. The UE 102, in an example, however, may not always use the bitrate that it is entitled to within a particular uplink flow. When radio resources are being allocated based only on the QFI in the UL direction, the spectrum can be underutilized. To resolve this, the access points 106 can implement an adaptive rate control mechanism in the UL direction. In one example, it is determined if the spectrum is underutilized as indicated in block (222). In one embodiment, the scheduler 107 in the AP 106 is configured to make the determination. In other embodiments other controllers and sensors are used to determine if the spectrum is underutilized.

If it is determined at block (222) the spectrum is not underutilized, allocation of the resources occurs based on the QFI as indicated at block (224). For example, in allocating resources, the WLAN access point 106 may use the network provided QFI (QoS values) to prioritize the UEs 102 to send buffer status request polling (BSRP).

If it is determined at block (222) the spectrum is underutilized, an implementation of an adaptive rate control mechanism in implement at block (226). The adaptive rate control mechanism may be based on applying machine learning tools/mechanisms designed to understand the behavior of the UE 102. Using machine learning (suitable regression model), access point 106 may further optimize resource allocation for UEs 102 in the UL direction even without a BSRP.

In an out of band application program interface (API) mode, the WLAN access point 106 or a WLAN controller (vSZ in case of Ruckus Access Points) may direct an interface or an API for N3IWF/TNGF 108 to provision/update/delete the QoS profile/QFI for each flow. This provisioning includes the mapping of Child_SA to QFI for every flow within a PDU session or per PDU session as provided by a core-access and mobility function (AMF) 112 in the packet core 110. The N3IWF/TNGF 108 may invoke this API after/before sending a PDU session establishment accept message to the UE 102.

In an in-band tunnel mode, whenever N3IWF/TNGF 108 wants to communicate an acceptance/modification of PDU session to a UE 102, the N3IWF/TNGF 108 inserts a proprietary header and append the respective message towards the UE 102. The extended header or proprietary header may carry all the information needed for an access point to enforce the requested QoS.

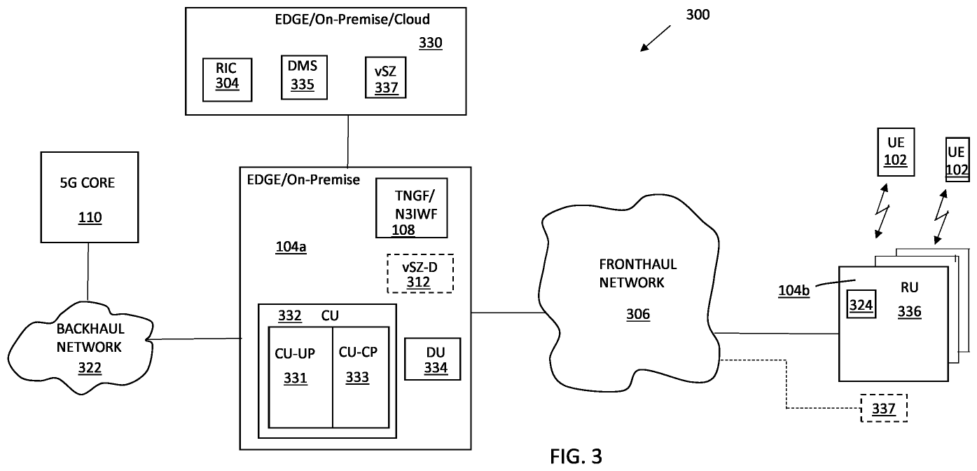

Referring to FIG. 3, a communication system 300, such as a radio access network, with cellular and local area network integration of an example embodiment is provided. The radio access network 300 that supports the use of licensed RF spectrum that is dedicated to providing 5G NR wireless service (for example, using the licensed RF spectrum licensed to a public wireless service operator). As shown in FIG. 3, the radio access network 300 includes at least one cellular base station 104a and 104b, generally indicated by 104.

In the exemplary embodiment shown in FIG. 3, each cellular base station 104 is implemented in a distributed manner in which each cellular base station 104 is partitioned into at least one central unit (CU) 332, at least one distributed unit (DU) 334, and one or more radio units (RUs) 336. Each CU 332 implements Layer 3 and non-time critical Layer 2 functions for the associated cellular base station 104. Each DU 334 is configured to implement the time critical Layer 2 functions and at least some of the Layer 1 (also referred to as the Physical Layer) functions for the associated cellular base station 104. Each CU 332 can be further partitioned into one or more user-plane and control-plane entities 331 and 333 that handle the user-plane and control-plane processing of the CU 332, respectively. Each such user-plane CU entity 331 is also referred to as a “CU-UP” 331, and each such control-plane CU entity 333 is also referred to as a “CU-CP” 333. In this example, each RU 336 is configured to implement the radio frequency (RF) interface and the Physical Layer functions for the associated cellular base station 104 that are not implemented in the DU 334. Although, FIG. 3 illustrates a 7.1.2 split cellular base station example, other examples may include a monolithic cellular base station (gNB) as well as other type split options.

In the exemplary configuration shown in FIG. 3, a single CU 332 serves a single DU 334, and the DU 334 shown in FIG. 3 serves three RUs 336. However, the configuration shown in FIG. 3 is only one example; other numbers of CUs 332, DUs 334, and RUs 336 can be used. Also, the number of DUs 334 served by each CU 332 can vary from CU to CU; likewise, the number of RUs 336 served by each DU 334 can vary from DU to DU.

Generally, each RU 336 is remotely located from each of the other RUs 336 as well as from the CU 332 and DU 334 serving it. Each RU 336 is communicatively coupled to the DU 334 serving it via a fronthaul network. Each RU 336 includes one or more network interfaces to couple that RU 336 to the fronthaul network 306. In this example, the fronthaul network 306 is implemented using a switched Ethernet local area network. Each RU 336 and the physical nodes on which each serving DU 334 is implemented includes suitable network interfaces to couple the RU 336 and the nodes to the fronthaul network 306 in order to facilitate communications between the DU 334 and the RUs 336.

In this example, the cellular base station 104 is configured to wirelessly communicate with one or more 5G NR wireless UEs 102 using the licensed RF spectrum licensed to one or more wireless operators. In such an example, each CU 332 is configured to communicate with the 5G core network 110 of the associated wireless operator using an appropriate backhaul network 322 (typically, a public wide area network such as the Internet).

The CU 332, as part of the cellular base station 104, may be located within (on-premise) of the coverage area 322 or near (edge of) the coverage area 322. The cellular base station 104 includes a plurality of cellular functions described above as defined by 3GPP/ORAN architecture. Gateway functions for non-3GPP access may be part of the core 110 in an example. The gateway functions may include TNGF/N3IWF 108 (network functions defined by 3GPP standardization body for Non-3GPP Access). The base station 104 may further include and an optional virtual smart zone data plane aggregation function (vSZ-D) 312. The optional vSZ-D 312 is a virtualized WLAN solution that assists in providing secure, high-performance, reliable and scalable WLAN services standards.

The radio access network 300, in this example, may also include a radio access network (RAN) intelligent controller (RIC) 304. RIC 304 may include radio connection management, mobility management, QoS management, edge services, and interference management, radio resource management, higher layer procedure optimization, policy optimization in RAN, and providing guidance, parameters, policies etc.

Further in communication with the radio access network 300 are other system control functions 330 which may also be located near the coverage area 322, within the coverage area 322 or located in the cloud. The system control functions 330 includes a device management system (DMS) 335. The DMS 335 manages and enables a configuration of the nodes of the cellular base station 104. Also included in the system control functions 330 is a virtual smart zone (vSZ) 337 which is the WLAN controller in this example. Further the overall radio access network (RAN) orchestration and management may be an integration of the DMS 335 and the vSZ 337. The DMS 335 provides the orchestration and management function for the cellular base station 104 and the vSZ 337 provides the WLAN controller in this example.

In the embodiment shown in FIG. 3, the RUs 336 used for implementing the cellular base station 104 may also include an WLAN access point 324 configured to communicate with UEs 102 using unlicensed RF spectrum and WLAN protocols. That is, each RU 336 in this example includes transceivers for both the wireless cellular service and WLAN service. The RUs 336 support both cellular and WLAN access technology in a coverage area in this communication system 300. In another embodiment, a WLAN access point 337 may be co-located with an associated RU 336.

The system configuration illustrated in FIG. 3 allows for traffic steering between cellular and WLAN service. Further it also allows for data offload or load balancing between cellular and WLAN service. Further in this example, the cellular base station 104 may hosts all functions as virtual functions (containerized network functions).

### Example Embodiments

Example 1 includes a method of operating a communication system with cellular and wireless local-area network (WLAN) integration. The method comprising in a downlink direction, selecting user information to be communicated to user equipment (UE) using a WLAN service; communicating quality of service (QoS) information associated with the user information generated by a cellular network to a WLAN access point; using a scheduler of the of WLAN access point to schedule downlink resources based on the QoS information; and wirelessly communicating the user information associated with the QoS information through the WLAN access point to at least one user equipment (UE) based on the scheduling of downlink resources by the scheduler.

Example 2 includes the method of Example 1, wherein the QoS information is a QoS flow identifier (QFI) and the QoS information relates to traffic prioritization and resource reservation control.

Example 3 includes the method of Example 2, wherein the QFI defines guaranteed minimum and maximum bitrates for each downlink flow of the communication information.

Example 4 includes the method of any of the Example 1-3, further including generating a protocol data unit (PDU) session including the QoS information with a packet core; using an interface to communicate the QoS information to a gateway function in a WLAN communication path; mapping security associations to QoS information with the gateway function; and communicating the mapping of security information to the WLAN access point.

Example 5 includes the method of Example 4, wherein the gateway function is one of a non-third generation (3GPP) interworking function (N3IWF) and a trusted non-3GPP gateway function (TNGF).

Example 6 includes the method of Example 4, further comprising further comprising an out of band application, the out of band application including: directing an interface to the gateway function to provision a QoS profile for each flow of communication information.

Example 7 includes the method of Example 4, further comprising an in-band application, the in-band application including: directing an interface to the gateway function to insert a propriety header in the communication information to the UE needed by the WLAN access point to enforce associated QoS information.

Example 8 includes the method of any of the Examples 1-7, further including determining if a spectrum in an uplink direction is being underutilized; and when it is determined the spectrum is not being underutilized, allocating resources using the QoS information.

Example 9 includes the method of Example 8, further including when it is determined the spectrum is being underutilized, implementing an adaptive rate control mechanism to allocate resources.

Example 10 includes the method of claim 9 wherein the adaptive rate control mechanism is based on a machining learning tool.

Example 11 includes a communication system with cellular and wireless local-area network (WLAN) integration. The communication system includes a cellular base station, a WLAN access point and gateway functions for non-3GPP access. The cellular base station provides a cellular wireless service to user equipment (UE). The cellular base station includes cellular functions defined by third-generation project (3GPP). The WLAN access point provides a WLAN wireless service to the UE. The WLAN access point includes a schedular. The cellular base station is configured to receive, using the gateway functions, quality of service (QoS) information associated with user information generated by a cellular packet core. The gateway functions are configured to map the QoS information and communicate the mapped QoS information to the WLAN access point. The scheduler of the WLAN access point configured to schedule resources for the WLAN wireless service based on the QoS information mapped by the gateway function.

Example 12 includes the communication system of Example 11, wherein the cellular packet core further includes an access and mobility management function (AMF) including management functions associated with security and a user plane function (UPF) to provide packet processing. The UPF being in communication with at least one data network.

Example 13 includes the communication system of any of the Examples 11-12, wherein the gateway function is one of a non-third generation (3GPP) interworking function (N3IWF) and a trusted non-3GPP gateway function (TNGF).

Example 14 includes the communication system of any of the Examples 11-13, wherein the QoS information is a QoS flow identifier (QFI) and the QoS information relates to traffic prioritization and resource reservation control.

Example 15 includes the communication system of any of the Examples 11-14, wherein the cellular base station further includes at least one radio unit for providing the cellular wireless service. The radio unit comprising the WLAN access point.

Example 16 includes the communication system of any of the Examples 11-15, further including system control functions that are in communication with the cellular base station. The system control functions include a device management system configured to manage and enable a configuration of the communication system and a virtual smart zone (vSZ) configured to control the WLAN access point.

Example 17 includes the communication system of any of the Examples 11-16, wherein the cellular base station further includes a virtual smart zone data plane aggregation function. The smart zone data plane aggregation configured to assist the WLAN access point in meeting at least one of secure, high-performance, reliable and scalable WLAN wireless services standards.

Example 18 includes a communication system with cellular and wireless local-area network (WLAN) integration. The communication system includes a cellular base station in communication with a cellular packet core with gateway functions for non-3GPP access. The cellular base station includes cellular functions defined by third-generation project (3GPP). The communication system further includes a radio unit to provide the cellular wireless service. The radio unit comprising a WLAN access point configured to provide WLAN wireless service.

Example 19 includes the communication system of Example 18, wherein the cellular functions further include a central unit to implement layer three and non-time critical layer two functions and a distributed unit configured to implement time critical layer two functions and at least some layer one functions.

Example 20 includes the communication system of any of the Examples 18-19, wherein the gateway functions for non-3GPP access further include one of a non-third generation (3GPP) interworking function (N3IWF) and a trusted non-3GPP gateway function (TNGF).

Example 21 includes the communication system of any of the Examples 18-20, further including a device management system (DMS) configured to manage and enable a configuration of the communication system and virtual smart zone (vSZ) configured to control the WLAN access point.

Example 22 includes the communication system of any of the Examples 18-21, wherein the communication system further includes a radio access network intelligent controller (RIC) configured to manage at least quality of service (QoS) functions.

Example 23 includes the communication system of any of the Examples 18-22, wherein the WLAN access point includes a scheduler. The gateway functions configured to map quality of service (QoS) information associated with user information to be delivered to user equipment (UE) and communicate the mapped QoS information to the WLAN access point. The scheduler of the WLAN access point configured to schedule resources based on the QoS information mapped by the gateway functions.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A method of operating a communication system with cellular and wireless local-area network (WLAN) integration, the method comprising in a downlink direction:
selecting user information to be communicated to user equipment (UE) using a WLAN service;
communicating quality of service (QoS) information associated with the user information generated by a cellular network to a WLAN access point;
using a scheduler of the of WLAN access point to schedule downlink resources based on the QoS information; and
wirelessly communicating the user information associated with the QoS information through the WLAN access point to at least one user equipment (UE) based on the scheduling of downlink resources by the scheduler.

2. The method of claim 1, wherein the QoS information is a QoS flow identifier (QFI) and the QoS information relates to traffic prioritization and resource reservation control.

3. The method of claim 2, wherein the QFI defines guaranteed minimum and maximum bitrates for each downlink flow of the communication information.

4. The method of claim 1, further comprising:
generating a protocol data unit (PDU) session including the QoS information with a packet core;
using an interface to communicate the QoS information to a gateway function in a WLAN communication path;
mapping security associations to QoS information with the gateway function; and
communicating the mapping of security information to the WLAN access point.

5. The method of claim 4, wherein the gateway function is one of a non-third generation (3GPP) interworking function (N3IWF) and a trusted non-3GPP gateway function (TNGF).

6. The method of claim 4, further comprising an out of band application, the out of band application including:
directing an interface to the gateway function to provision a QoS profile for each flow of communication information.

7. The method of claim 4, further comprising an in-band application, the in-band application including:
directing an interface to the gateway function to insert a propriety header in the communication information to the UE needed by the WLAN access point to enforce associated QoS information.

8. The method of claim 1, further comprising:
determining if a spectrum in an uplink direction is being underutilized; and
when it is determined the spectrum is not being underutilized, allocating resources using the QoS information.

9. The method of claim 8, further comprising:
when it is determined the spectrum is being underutilized, implementing an adaptive rate control mechanism to allocate resources.

10. The method of claim 9, wherein the adaptive rate control mechanism is based on a machining learning tool.

11. A communication system with cellular and wireless local-area network (WLAN) integration, the communication system comprising:
a cellular base station providing a cellular wireless service to user equipment (UE), the cellular base station including cellular functions defined by third-generation project (3GPP);
a WLAN access point providing a WLAN wireless service to the UE, the WLAN access point including a scheduler;
gateway functions for non-3GPP access; and
wherein the cellular base station is configured to receive, using the gateway functions, quality of service (QoS) information associated with user information generated by a cellular packet core, the gateway functions configured to map the QoS information and communicate the mapped QoS information to the WLAN access point, the scheduler of the WLAN access point configured to schedule resources for the WLAN wireless service based on the QoS information mapped by the gateway function.

12. The communication system of claim 11 wherein the cellular packet core further comprises:
an access and mobility management function (AMF) including management functions associated with security; and
a user plane function (UPF) to provide packet processing, the UPF being in communication with at least one data network.

13. The communication system of claim 11, wherein the gateway function is one of a non-third generation (3GPP) interworking function (N3IWF) and a trusted non-3GPP gateway function (TNGF).

14. The communication system of claim 11, wherein the QoS information is a QoS flow identifier (QFI) and the QoS information relates to traffic prioritization and resource reservation control.

15. The communication system of claim 11, wherein the cellular base station further comprises:
at least one radio unit for providing the cellular wireless service, the radio unit comprising the WLAN access point.

16. The communication system of claim 11, further comprising:
system control functions in communication with the cellular base station, the system control functions including,
a device management system configured to manage and enable a configuration of the communication system; and
a virtual smart zone (vSZ) configured to control the WLAN access point.

17. The communication system of claim 11, wherein the cellular base station further comprises:
a virtual smart zone data plane aggregation function, the smart zone data plane aggregation configured to assist the WLAN access point in meeting at least one of secure, high-performance, reliable and scalable WLAN wireless services standards.

18. A communication system with cellular and wireless local-area network (WLAN) integration, the communication system comprising:
a cellular base station in communication with a cellular packet core with gateway functions for non-3GPP access, the cellular base station including,
cellular functions defined by third-generation project (3GPP); and
a radio unit to provide cellular wireless service, the radio unit comprising a WLAN access point configured to provide WLAN wireless service.

19. The communication system of claim 18, wherein the cellular functions further comprise:
a central unit to implement layer three and non-time critical layer two functions; and
a distributed unit configured to implement time critical layer two functions and at least some layer one functions.

20. The communication system of claim 18, wherein the gateway functions for non-3GPP access further comprises:
one of a non-third generation (3GPP) interworking function (N3IWF) and a trusted non-3GPP gateway function (TNGF).

21. The communication system of claim 18, further comprising:
a device management system (DMS) configured to manage and enable a configuration of the communication system, and
a virtual smart zone (vSZ) configured to control the WLAN access point.

22. The communication system of claim 18, wherein the communication system further comprises:
a radio access network intelligent controller (RIC) configured to manage at least quality of service (QoS) functions.

23. The communication system of claim 18, wherein the WLAN access point includes a scheduler, the gateway functions configured to map quality of service (QoS) information associated with user information to be delivered to user equipment (UE) and communicate the mapped QoS information to the WLAN access point, the scheduler of the WLAN access point configured to schedule resources based on the QoS information mapped by the gateway functions.
